(19) United States
(12) Patent Application Publication
(10) Pub. No.: US 2008/0318109 A1
(43) Pub. Date: Dec. 25, 2008

(54) Method for the production of a sulfonated poly (1, 3, 4-oxadiazole) polymer

(75) Inventors: Dominique de Figueiredo Gomes, Geesthacht (DE); Jerusa Roeder Jesus, Siegburg (DE); Suzana Nunes, Geesthacht (DE)

Correspondence Address: MICHAUD-DUFFY GROUP LLP, 306 INDUSTRIAL PARK ROAD, SUITE 206, MIDDLETOWN, CT, 06457, US

(73) Assignee: GKSS-Forschungszentrum Geesthacht GmbH, Geesthacht (DE)

(21) Appl. No.: 12/215,054

(22) Filed: Jun. 24, 2008

(30) Foreign Application Priority Data
Jun. 25, 2007 (DE) 10 2007 029 542.3

(51) Int. Cl. H01M 8/10; C08G 69/26

(52) U.S. Cl. 429/33; 528/336; 29/623.1

(57) ABSTRACT

A sulfonated poly(1,3,4-oxadiazole) polymer is produced by producing of a solution of hydrazine sulfate salt and a non-sulfonated dicarboxylic acid or derivative thereof in polyphosphoric acid; heating the solution under an inert gas atmosphere; and precipitating sulfonated poly(1,3,4-oxadiazole) polymer in a basic solution.

### CROSS-REFERENCE TO RELATED APPLICATIONS

This application claims the priority of German Application Number DE 10 2007 029 542.3, filed on Jun. 25, 2007, which is hereby incorporated herein by reference, in its entirety.

### FIELD OF THE INVENTION

The invention relates to a method for the production of a sulfonated poly(1,3,4-oxadiazole) polymer. The invention further relates to a sulfonated poly(1,3,4-oxadiazole) polymer, a membrane for fuel cells, a fuel cell and a method for the production of a fuel cell.

### BACKGROUND

Fuel cells require proton-conducting membranes. Such membranes are for example polymer electrolyte membranes (PEMs). A known PEM based on a perfluorocarbon polymer electrolyte membrane is the Nafion® membrane developed by DuPont (JP 112 04 119 A).

Two types of PEM fuel cells are being developed, namely low-temperature cells, which are operated up to approx. 90° C., and high-temperature cells, which are operated up to approx. 180° C.

The Nafion® membrane does not have sufficient heat resistance for use at a temperature exceeding 80° C. (also see U.S. Pat. No. 4,330,654). Low-temperature fuel cells are sensitive to carbon monoxide, which can block the anode catalyst, leading to a loss of power. Humidification of the membrane is essential so that the protons can be conducted. Moreover, the environmental impact during the synthesis or disposal of the membrane is great since a large amount of fluorine is used.

In past years, work has been done on highly functional polymer materials that not only have high heat resistance and high chemical resistance but also electrical conductivity. As one method for the production of a material with electrical conductivity, an experiment was performed to introduce ion-exchangeable functional groups (e.g. sulfo groups) to the polymers. Japanese patent document JP 111 16 679 A thus discloses polyarylene ether sulfones with a sulfo group bonded directly to an aromatic ring of the main chain. Japanese patent document JP 907 39 08 A further discloses polybenzimidazoles with a sulfoalkyl group bonded directly to an aromatic ring of the main chain. Further examples are SPEEK (sulfonated poly(ether ether ketone)), SPEES (sulfonated poly(ether ether sulfone)), SPI (sulfonated polyimide), polybenzimidazole, polyethersulfone, etc.

Polyoxadiazoles have high glass transition temperatures in addition to high chemical and thermal stability. For applications in membranes for fuel cells, ultrafiltrations, electrodialyses, which require high electrical conductivity, ion-exchangeable functional groups such as sulfo groups can be introduced to these polymers.

Iwakura et al. (Y. Iwakura, K. Uno, S. Hara, J. Polym. Sci.: Part A 1965, 3, 45 through 54) first disclosed a method for the production of a polyoxadiazole based on the reaction of a hydrazine sulfate with dicarboxylic acid. After this publication, the correlations between the properties of the created polyoxadiazoles with the synthesis parameters remained unclear for a long time. Up to now, many aspects with respect to the synthesis of polyoxadiazoles with high molecular weight in polyphosphoric acid have not be exhaustively studied and understood.

Gomes et al. (D. Gomes, C. P. Borges, J. C. Pinto, Polymer 2001, 42, 851 through 865; Polymer 2004, 45, 4997 through 5004; D. Gomes, S. P. Nunes, J. C. Pinto, C. P. Borges, Polymer 2003, 44, 3633 through 3639) performed a systematic study on the impact of different synthesis parameters on the final properties of a polyoxadiazole with a diphenyl ether group, which is connected with the main chain of the polymer. This study performed an optimization of the polymer properties, e.g. the molecular weight and the remaining hydrazite groups, with the help of a statistical experimental design.

JP 63118331 AA discloses a method for the production of a polyoxadiazole with high efficiency, wherein a dicarboxylic acid and a hydrazine sulfate are condensed using a mixture of phosphoric pentoxide and methane sulfonic acid as the condensation means.

RU 2263685 discloses a method for the production of poly(1,3,4-oxadiazole) with molecular masses of 60,000 to 450,000 Da. The poly(1,3,4-oxadiazole) can be used in the development of highly thermally stable, chemically stable and mechanically stable materials. The method includes a polycondensation reaction of dicarboxylic acid with hydrazine derivatives or with dicarboxylic acid dihydrazide at a temperature of 190° C. through 220° C., which is performed in a solvent for a duration of three to seven hours and takes place in the presence of triphenyl phosphite.

Gomes et al. (2004, see above) optimized the experimental requirements under which reproducible polyoxadiazole samples with a high molecular weight, high solubility in organic solvents and low residual hydrazide groups can be prepared without the addition of triphenyl phosphite. However, the sulfonation of the polyoxadiazoles with hydrazine sulfate at temperatures of over 140° C. was not examined. It was also entirely overlooked in the literature.

Hensema et al. (E. R. Hensema, J. P. Boom, M. H. V. Mulder, C. A. Smolders, Polym. Sci.: Part A: Polym. Chem. 1994, 32, 513 through 525; E. R. Hensema, M. E. R. Sena, M. H. V. Mulder, C. A. Smolders, J. Polym. Sci.: Part A: Polym. Chem. 1994, 32, 527 through 537) detected sulfur up to 0.9 wt. % through elementary analysis. However, it was assumed that the remaining sulfur was present as free H₂SO₄ and was not bonded to the polymer. Differences in the elementary analysis between the experimental and the theoretical values were interpreted as residual impurities, most likely in the form of phosphoric acid.

Gomes et al. (D. Gomes, J. Roeder, M. L. Ponce, S. P. Nunes, J. Membr. Sci. 2007, to be published) proved experimentally the sulfonation of polyoxadiazole during the synthesis of the polyoxadiazole using hydrazine sulfate in polyphosphoric acid. The structure of the polymer was qualitatively and quantitatively characterized through elementary analysis, ¹H-NMR and FTIR. A polymer with a high molecular weight (358,000 g/mol) was produced with a high stability with respect to oxidation. The polymer allows the production of mechanically stable membranes with a high storage modulus (approx. 4 GPa at 100° C.). Although the sulfonated polymer was produced using the synthesis conditions described and optimized by Gomes et al., 2004 (see above), a low sulfonation rate of 17 to 18 was measured at a molar ratio of sulfur to carbon (S/C) of 0.065 at 4.1 wt. % sulfur.

Roeder et al. (J. Roeder, D. Gomes, M. L. Ponce, V. Abetz and S. P. Nunes, Makromol. Chem. Phys. 2007, 208, 467 through 473) examined the effect of sulfonic acid protonization on the properties of sulfonated poly(1,3,4-oxadiazole) membranes with the help of infrared and impedance spectroscopy. Based on the publication of Gomes et al., 2004 (see above), hydrazine sulfate salt and an aromatic dicarboxylic acid were used in polyphosphoric acid for three hours, wherein an optimization of the synthesis conditions was performed for the synthesis of sulfonated poly(1,3,4-oxadiazole). A low sulfonation level of 15 to 17 was determined at a molar ratio of sulfur to carbon (S/C) of 0.0573 to 0.0637.

Perfluorinated polymer electrolyte membranes such as the Nafion® membrane have been used to a large extent in practice as polymer electrolytes for fuel cells (PEFCs) due to their excellent chemical stability and proton conductivity. The disadvantage of these membranes is their high cost and the decrease in proton conductivity at temperatures above 100° C. and in the case of low humidity. Thus, a plurality of new, lower cost polymer electrolyte materials were developed which are stable and are also able to retain their proton conductivity even at high temperatures and low humidity.

DE 102 46 373 A1 discloses a proton-conductive polymer membrane based on polyazole, which was obtained by heating a mixture of (hetero)aromatic monomers (tetramino compounds and polycarboxylic acid or diamino carboxylic acid, at least a few of which have sulfonic acid groups) in polyphosphoric acid, and the subsequent production of a self-supporting membrane.

CA 2499946 A1 describes a new class of proton-exchange membrane materials, sulfonated poly(phtalazinone). The sulfonation reactions are performed at room temperature using mixtures of 95% to 98% concentrated hydrochloric acid and 27% to 33% fuming hydrochloric acid with different acid ratios.

U.S. Pat. No. 4,634,530 A describes a method for the chemical modification of a prefabricated semipermeable polybenzimidazole membrane. The method includes the step of sulfonating the membrane through contact with a sulfonating agent. The membrane is then heated under an inert atmosphere to a temperature and for a duration that are sufficient to convert the ionic bonds, which are formed in the contacting step, into permanent, covalent bonds so that a semi-permeable membrane made of covalently bonded sulfonated polybenzimidazole is produced.

KR 102006001626 A discloses a method for the production of a sulfonated polybenzimidazole, wherein the polymerization is performed in the presence of at least one of the catalysts selected from a group made up of potassium carbonate, sodium carbonate and lithium carbonate.

### SUMMARY OF THE INVENTION

The present invention resides in one aspect in a method for the production of a sulfonated poly(1,3,4-oxadiazole) polymer by producing a solution by mixing hydrazine sulfate salt with a non-sulfonated dicarboxylic acid or derivative thereof in polyphosphoric acid; heating the solution under an inert gas atmosphere; and precipitating sulfonated poly(1,3,4-oxadiazole) polymer in a basic solution.

The present invention resides in another aspect in a membrane for fuel cells, the membrane being made of a sulfonated poly(1,3,4-oxadiazole) polymer which is produced as described herein, wherein sulfonic acid groups are bonded with the main chain of the polymer, and wherein the membrane has a feed side and a permeate side.

The present invention also resides in a method for the production of a fuel cell. The method includes producing a membrane having a feed side and a permeate side and disposing the membrane between two porous catalyst electrodes made of platinum or a platinum alloy. The feed side of the membrane contacts an anode and the permeate side of the membrane contacts a cathode.

### BRIEF DESCRIPTION OF THE FIGURES

FIG. 1 is a graph that shows an FTIR (Fourier Transform Infrared) spectrum of a sulfonated poly(1,3,4-oxadiazole) membrane.

FIG. 2 is a graph that shows the sulfonation degree of sulfonated poly(1,3,4-oxadiazole) samples as a function of the reaction time after sulfonation.

FIG. 3 is a graph that shows the proton conductivity of a sulfonated poly(1,3,4-oxadiazole) membrane as a function of relative humidity.

### DETAILED DESCRIPTION

This invention provides a method for the production of a sulfonated poly(1,3,4-oxadiazole) polymer in a single-stage polycondensation reaction of a hydrazine sulfate salt with a non-sulfonated dicarboxylic acid or derivative thereof, i.e., with one or more non-sulfonated dicarboxylic acids or their non-sulfonated derivatives, in polyphosphoric acid, with the following steps: producing a solution by mixing the hydrazine sulfate salt with one or more dicarboxylic acids or their derivatives in polyphosphoric acid; heating the solution under an inert gas atmosphere; and precipitating the polymer in a basic solution.

The polymer is advantageously neutralized in the basic solution.

For use in electrochemical cells, sulfonated polymers desirably achieve high ion-conductivity values, which can be achieved through an increase in the sulfonation level.

In addition to providing high ion conductivity, the sulfonation of polymers can also improve their other properties, e.g. wettability, anti-fouling properties and the solubility in solutions for the use of polymers, and can lead to higher gas permeability and proton conductivity.

For the sulfonation of polymers, sulfonated monomers can be used during synthesis, or polymers may be combined under different conditions with sulfonation means, such as sulfuric acid, sulfur trioxide, trimethylsilyl chlorosulfonate, chlorosulfonic acid or a mixture of these reagents.

It is possible with the method according to the invention to produce sulfonated polyoxadiazoles with a sulfonation level above 22, a molar ratio of sulfur to carbon (S/C) in the range of about 0.085 to about 0.38:1 and a weight average molecular weight on the order of magnitude of 10⁵ g/mol, which have high proton conductivity at low humidities and excellent mechanical properties and are oxidatively, chemically and thermally stable. (As used herein in reference to a polymer, the terms “molar weight,” “molecular weight” and “average molecular weight” refer to a weight-average molecular weight unless another type of molecular weight is specified or required or implied in a particular context.)

The single-stage polycondensation reaction saves time and costs and leads to a higher degree of sulfonation.

The non-sulfonated dicarboxylic acid or derivative thereof may include one or more dicarboxylic acids or mixtures of one or more dicarboxylic acids and one or more dicarboxylic acid diesters, or derivatives thereof. The non-sulfonated dicarboxylic acid or derivative thereof preferably comprises an aromatic and/or heteroaromatic dicarboxylic acid group.

The preferably aromatic and/or heteroaromatic dicarboxylic acid group preferably includes at least one electron-donor substituent or a multi-ring system with at least one —O— connecting link between the aromatic rings.

The heating preferably takes place at a temperature of about 160° C. to about 200° C., optionally at about 160° C. to about 180° C.

The heating preferably takes place for a duration of about 4 to about 24 hours (h), especially preferably about 4 to about 16 h, most preferably about 6 to about 8 h. When larger amounts of monomers are used, the method fluctuations are decreased and the molecular weight is increased. It is thus advantageous if the amount of hydrazine sulfate salt is at least about 12 grams (g).

A poly(1,3,4-oxadiazole) is defined in connection with the invention as a polymer that has at least one conjugated ring, which has two nitrogen atoms and one oxygen atom. Specific poly(1,3,4-oxadiazoles), which can be used, include poly(ether sulfone oxadiazole), poly(ether ketone oxadiazole), poly(ether amide oxadiazole), poly(ether imide oxadiazole). The preferred polymer has repeating units of the following structural formula (I):

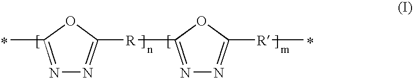

The remainders R, R′ preferably have aromatic or heteroaromatic groups that have at least one electron-donor substituent or a multi-ring system, and that have at least one —O— connecting link between the aromatic rings, in order to benefit the sulfonation reaction.

This invention also provides a sulfonated poly(1,3,4-oxadiazole) polymer, including a homo- and/or copolymer, that can be obtained by the method described herein.

The sulfonated poly(1,3,4-oxadiazole) polymer preferably is or contains a sulfonated poly(1,3,4-oxadiazole) homopolymer and/or a sulfonated poly(1,3,4-oxadiazole) copolymer.

Advantageously, in particular for a high proton conductivity, the sulfonated poly(1,3,4-oxadiazole) polymer has a sulfonation degree of about 23 to about 100, preferably about 28 to about 100, more preferably about 35 to about 100. Here, the sulfonation degree is defined as 100 when each phenylene ring of the polymer chain has a sulfonic acid group bound chemically to the phenylene ring. The sulfonation degree is determined by means of elementary analysis, NMR, infrared spectroscopy or titration. In this context, a chemical bond is in particular a covalent bond.

The sulfonated poly(1,3,4-oxadiazole) polymer preferably has a weight average molecular weight on the order of magnitude of 10⁵ g/Mol.

The sulfonated poly(1,3,4-oxadiazole) polymer also preferably has a molar ratio of sulfur to carbon (S/C) of about 0.085 to about 0.38:1, in particular preferably about 0.1 to about 0.38:1, even more preferably about 0.125 to about 0.38:1. The sulfur to carbon ratio (S/C) can be determined by means of elementary analysis.

The poly(1,3,4-oxadiazole) is preferably a poly(ether sulfone oxadiazole), a poly(ether ketone oxadiazole), a poly(ether amide oxadiazole), or a poly(ether imide oxadiazole). The sulfonated poly(1,3,4-oxadiazole) polymer according to the invention has a high oxidation stability. The polymer especially preferably retains at least about 98% of its weight after a one-hour immersion in Fenton's reagent at 80° C.

This invention also provides a membrane for fuel cells that can be made of a sulfonated poly(1,3,4-oxadiazole) polymer obtained as described herein, in which sulfonic acid groups are bonded with the main chain of the polymer, and wherein the membrane has a feed side and a permeate side.

The membrane preferably has a separation layer, which contains mixtures or copolymers of the sulfonated poly(1,3,4-oxadiazole) polymer with other polymers.

Preferably, the membrane is doped with acids and/or oligomers, which have functional acid groups and/or polymers with functional acid groups. The properties of the membrane can thereby be further regulated.

In one embodiment, a membrane as described herein may have a proton conductivity of at least about 4.9×10⁻² S/cm at 80° C. and a relative humidity of about 15%.

In some embodiments, a fuel cell that includes a membrane as described herein works at a relative humidity of less than about 20%.

In one embodiment, a fuel cell can be produced by producing an electrolyte membrane that has a feed side and a permeate side and disposing the electrolyte membrane between two porous catalyst electrodes made of platinum or a platinum alloy with the feed side of the membrane in contact with an anode and the permeate side of the membrane in contact with a cathode. A fuel containing the reactive components is fed into the anode such that protons can migrate through the membrane. An oxidizing agent, preferably oxygen, fills the space with the cathode, and the components obtained in this manner are then pulled back into the cathode space.

The membrane comprises a layer made of a polymer electrolyte with the sulfonated poly(1,3,4-oxadiazole) polymer and/or copolymers that are derived from the sulfonated poly(1,3,4-oxadiazole) polymer, wherein sulfonic acid groups are chemically or covalently bonded to the main polymer chains in the polymer electrolyte layer. The separation layer can also have mixtures or copolymers of the polymers defined above with other polymers.

Hydrogen, methanol or ethanol can be used as the fuel supplied to the anode, wherein methanol and ethanol can be used in liquid form or as mixtures of water and gaseous methanol or ethanol.

Particular embodiments of the invention are illustrated by the following examples, with reference to the accompanying Figures, which are not intended to limit or restrict the general intent of the invention.

### EXAMPLE 1

### Synthesis of sulfonated poly(1,3,4-oxadiazole)

### Direct Synthesis

Polyphosphoric acid (PPA) was first added to a flask and heated to 100° C. under a dry nitrogen atmosphere. Hydrazine sulfate salt (HS) (>99%, Aldrich) was then added to the polyphosphoric acid and homogenized through the stirring and beating of the reaction medium.

After reaching the reaction temperature, dicarboxylic diazide 4,4′-diphenyl ether (DPE) (99%, Aldrich), was added to the flask. The molar dilution ratio (PPA/HS) and the molar monomer ratio (HS/DPE) were held constant at 10 and 1.2 respectively. The molar dilution ratio (PPA/HS) and the molar monomer ratio (HS/DPE) were selected according to an earlier study, in which the synthesis of poly(ether 1,3,4-oxadiazole) was optimized with the help of a statistical experimental design (Gomes et al., 2001, see above).

After a reaction time of DPE and HS of six hours, the reaction medium was added to water with 5% weight to volume (w/v) of sodium hydroxide (99%, Vetec) in order to precipitate the polymer. The pH value of this polymer suspension was checked according to Gomes et al., 2004 (see above). The chemical structure of the polymer is as follows in structural formula (II):

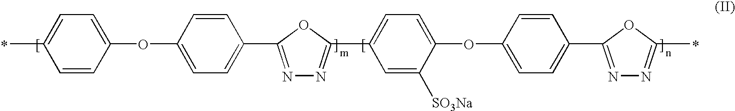

Sulfonated poly(1,3,4-oxadiazole) with a molar ratio of sulfur to carbon (S/C) of 0.124 was obtained according to an elementary analysis, at 5.7% wt. % sulfur and a sulfonation degree of 32.5%, wherein the sulfonation degree is 100 when the molar ratio of sulfur to carbon (S/C) is equal to 0.38. The sulfonated poly(1,3,4-oxadiazole) was soluble in the solvents 1-methyl-2-pyrrolidinone (NMP) and dimethylsulfoxide (DMSO) and had an average molecular weight of 470,000 g/mol.

The average molecular weight was measured by means of size exclusion chromatography (SEC). A Viscotek SEC apparatus, which was equipped with Eurogel columns SEC 10,000 and PSS gram 100, 1,000 with serial numbers HC286 and 1515161 with a size of 8×300 mm, was used to determine the weight-averaged molecular weights of the polymer samples. The device was calibrated using polystyrene standards (Merck), wherein the polystyrene standards have weight-averaged molecular weights in the range of 309 to 944,000 g/mol. A solution with 0.05 M lithium bromide in dimethylamide acetate (DMAc) was used as the carrier.

FIG. 1 shows the infrared spectrum of the sulfonated poly(1,3,4-oxadiazole) with a molar ratio of sulfur to carbon (S/C) of 0.124 measured by means of elementary analysis. The graph shows that the sulfonic acid groups are chemically bonded, i.e. covalently bonded, to the polymer chain. In addition to the distribution maxima at 1,600 and 1,487 cm⁻¹, which result from C═C dilation of the aromatic groups, the maxima at 1,467 cm⁻¹ and 1.413 cm⁻¹ correlate with a C═N dilation of the oxadiazole ring group, and the maximum at 1,085 cm⁻¹ correlates with a —C—O—C— dilation. The asymmetric SO₂ dilation has a maximum at 1,394 cm⁻¹.

In covalent sulfonates, R—SO₂—OR, the asymmetric dilation vibration band appears at 1,420 through 1,310 cm⁻¹. Symmetric SO₃ dilation vibration bands of sulfonic acid salts (SO₃-M+) appear at 1,070 to 1,030 cm⁻¹. This band is observed at 1,030 cm⁻¹ for the polyoxadiazole that was synthesized in PPA from HS.

### Post Sulfonation

A sulfonated poly(1,3,4-oxadiazole) polymer was post-sulfonated for different durations in order to increase the sulfonation level.

According to elementary analysis, infrared spectroscopy and nuclear magnetic resonance (NMR), the sulfonated poly(1,3,4-oxadiazole) polymer used as the starting material, which was synthesized under the conditions according to Gomes et al. (2004, 2007, see above) had a molar ratio of sulfur to carbon (S/C) of 0.057 to 0.072 and contained 4.1 wt. % sulfur. The sulfonation degree was 15% to 18.9%. The polymer was soluble in the solvent 1-methyl-2-pyrrolidinone (NMP) and had an average molecular weight of 358,000 g/mol according to SEC.

One gram of this sulfonated poly(1,3,4-oxadiazole) polymer was dissolved in 15 ml of concentrated hydrochloric acid (95% to 98%) and vigorously stirred at 45° C. This treatment was performed for periods of time ranging from one day (24 hours) to 40 days (960 hours). The polymer solution was then gradually precipitated in ice-cold K₂CO₃-containing water under mechanical stirring until a neutral pH value was reached.

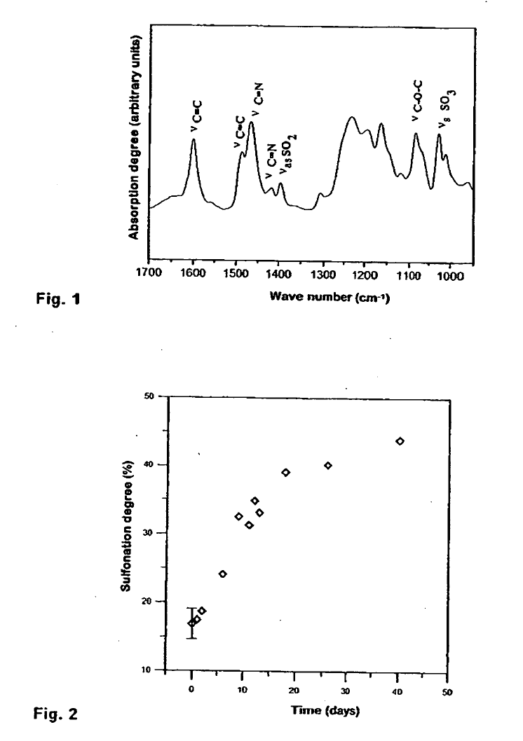

The polymer precipitate was filtered, washed multiple times with distilled water and dried for 12 hours at 80° C. FIG. 2 shows the sulfonation degree achieved after the different durations of the post-treatment determined using elementary analysis.

FIG. 2 shows that the sulfonation degree was well-controlled for each duration. However, one disadvantage of this method with respect to the direct synthesis according to the invention is the longer duration needed to achieve the same sulfonation degree. For example, a sulfonation degree of 32.5% was only achieved after 11 days.

Another disadvantage is that a lower molecular weight, e.g., a molecular weight on the order of magnitude of 10⁴ g/mol, was achieved, at a post-sulfonation reaction time of more than nine days, in order to achieve a molar ratio of sulfur to carbon (S/C)>0.12 or a sulfonation degree of more than 31%.

Thus, under the optimized sulfonation reaction conditions, the direct sulfonation reaction represents an efficient method for producing sulfonated poly(1,3,4-oxadiazole) with lower reaction times and higher molecular weights than post-sulfonation reactions.

### Membrane Production

Homogenous membranes made of sulfonated poly(1,3,4-oxadiazole) polymer solutions with a concentration of 4 wt. % were poured into DMSO. After pouring, the DMSO was evaporated in a vacuum furnace for 24 hours at 60° C. For the removal of other remaining solvents, the membranes were immersed into a water bath for 48 hours at 60° C. and dried in a vacuum furnace for 24 hours at 60° C. The final thickness of the membranes was 30 μm.

The sulfonated poly(1,3,4-oxadiazole) membranes were converted to their acid form through immersion in 1.6M H₃PO₄ for 24 hours at room temperature and subsequent immersion in a water bath for 2 times 24 hours in order to ensure a complete removal of the remaining phosphoric acid.

### EXAMPLE 2

### Water Absorption and Oxidation Stability

The membranes were dried before the measurement in a vacuum for 24 hours at 80° C. After the measurement of the weights of the dried membranes, the samples were immersed in deionized water for 24 hours at 25° C. and 60° C.

Before the measurement of the weights of the hydrated membranes, the water was removed from the membrane surfaces by dabbing with paper towels. The water absorption was calculated according to the following formula:

water absorption (in wt. %)=(m_{wet}−m_{dry})/m_{dry}×100,

wherein m_{wet} and m_{dry} are the weights of the dry and the hydrated membranes.

The oxidative stability of the membranes was examined in that the membranes were immersed in Fenton's reagent (3% H₂O₂ with 2 ppm FeSO₄) for one hour at 80° C. The results are shown in Table 1.

TABLE 1
Water absorption and oxidation stability of sulfonated
poly(1,3,4-oxadiazole) membranes

| | | |
|---|---|---|
| | Water absorption | Remaining after |
| S/C | (wt. %) | oxidative test |

| (molar ratio)^{a} | 25° C. | 60° C. | (wt. %)^{c} |
|---|---|---|---|
| 0.065^{b} | 19 | 21 | 98 |
| 0.124 | 37 | 42 | 98 |

^{a}Based on elementary analysis
^{b}Data from Gomes et al., 2007 (see above)
^{c}After a one-hour bath in Fenton's solution at 80° C.

The data of Table 1 shows that water absorption increases with an increasing sulfonation degree and with the temperature. With an increasing sulfonation degree, the increase in the number of sulfonic acid groups leads to a higher water absorption. The water within the membrane represents a carrier for protons and leads to the increased proton conductivity values, which go along with membranes with a higher molar ratio of sulfur to carbon (S/C) or with a higher sulfonation degree.

The membrane stability with respect to oxidation was examined in that the membrane was immersed in Fenton's reagent for one hour at 80° C. This method was used to simulate an oxidative reaction through the attack of radicals (HO. und HOO.) during the operation of fuel cells.

The sulfonated poly(1,3,4-oxadiazole) membranes showed a high oxidative stability wherein they retained 98% of their weight in the test. The high chemical stability of the sulfonated poly(1,3,4-oxadiazole) membranes can be explained in that the chemical stability of the polymer chains is increased through heterocyclic rings.

The molar ratio of sulfur to carbon was determined through elementary analysis. The residue after the oxidative tests was also determined through elementary analysis. The data in the third column stems from Gomes et al. (2007).

### EXAMPLE 3

### Measurement of the Proton Conductivity

The proton conductivity was measured using AC impedance spectroscopy at frequencies between 10 to 10⁶ Hz at a signal amplitude of ≦100 mV and was determined from the impedance modulus at a vanishing phase shift on the high frequency side. The proton conductivity of the samples was determined at 80° C. and a relative humidity between 15% and 100%. The impedance measurements were performed on stacks of up to 5 membranes, wherein the stacks each had a similar overall thickness of approx. 500 μm. The relative humidity was controlled by blowing nitrogen gas through water that was heated to a suitable temperature between 20° C. and 80° C.

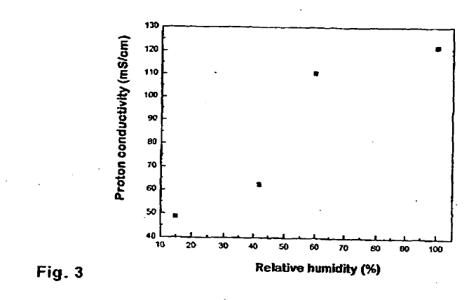

FIG. 3 shows the proton conductivity of the sulfonated poly(1,3,4-oxadiazole) membrane as a function of the temperature. The membrane had an S/C=0.124, measured at 80° C. and a relative humidity of 15% to 100%.

FIG. 3 shows that a high proton conductivity was achieved and can among other things be explained with the structure of the sulfonated poly(1,3,4-oxadiazoles). The sulfonated poly(1,3,4-oxadiazoles) contain in their structure both donor and acceptor hydrogen atoms, which can conduct protons through disassociation from their anionic counter-ions.

Another explanation for the high proton conductivity is the hydrophilicity and flexibility of the polymer chains based on diphenyl ether groups bonded to the main chains, which probably benefits proton jumps through the pyridine-like N-locations and the sulfonic acid groups even at low humidity.

At 80° C. and a relative humidity of 100%, a sulfonated poly(1,3,4-oxadiazole) membrane with S/C=0.065 produced according to Gomes et al., 2007 (see above) reached a proton conductivity of 10 mS/cm, while in contrast under the same conditions the sulfonated poly(1,3,4-oxadiazole) membrane with S/C=0.124 had a proton conductivity of 120 mS/cm. The result is explained by the higher sulfonation degree of the sulfonated poly(1,3,4-oxadiazole) with S/C=0.124.

Unless otherwise specified, all ranges disclosed herein are inclusive and combinable at the end points and all intermediate points therein.

The terms “first,” “second,” and the like, herein do not denote any order, quantity, or importance, but rather are used to distinguish one element from another.

The terms “a” and “an” herein do not denote a limitation of quantity, but rather denote the presence of at least one of the referenced item.

Terms herein that include a numerical value preceded the term “about” are intended to include, but not require, the precise numerical value stated in the term, and to encompass variations that achieve the stated characteristics or at least standard uncertainties in the reported value.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for the production of a sulfonated poly(1,3,4-oxadiazole) polymer, comprising:
producing a solution by mixing hydrazine sulfate salt with a non-sulfonated dicarboxylic acid or derivative thereof in polyphosphoric acid;
heating the solution under an inert gas atmosphere; and
precipitating sulfonated poly(1,3,4-oxadiazole) polymer in a basic solution.

2. The method according to claim 1, wherein the polymer is neutralized in the basic solution.

3. The method according to claim 1, wherein the non-sulfonated dicarboxylic acid or derivative thereof comprises an aromatic and/or heteroaromatic dicarboxylic acid group.

4. The method according to claim 3, wherein the aromatic and/or heteroaromatic dicarboxylic acid group has at least one electron-donor substituent or a multi-ring system with at least one —O— connecting link between the aromatic rings.

5. The method according to claim 1, wherein the heating takes place at a temperature of about 160° C. to about 200° C.

6. The method according to claim 1, including heating for about 4 h to about 24 h.

7. The method according to claim 1, wherein the amount of hydrazine sulphate salt is at least about 12 grams.

8. A sulfonated poly(1,3,4-oxadiazole) polymer produced by the method of claim 1.

9. The sulfonated poly(1,3,4-oxadiazole) polymer according to claim 8, wherein the polymer comprises a sulfonated poly(1,3,4-oxadiazole) homopolymer.

10. The sulfonated poly(1,3,4-oxadiazole) polymer according to claim 8, wherein the polymer comprises a sulfonated poly(1,3,4-oxadiazole) copolymer.

11. The sulfonated poly(1,3,4-oxadiazole) polymer according to claim 8, wherein the sulfonated poly(1,3,4-oxadiazole) polymer has a sulfonation degree of about 23 to about 100.

12. The sulfonated poly(1,3,4-oxadiazole) polymer according to claim 8, wherein the sulfonated poly(1,3,4-oxadiazole) polymer has a weight average molecular weight on the order of magnitude of 10⁵ g/Mol.

13. The sulfonated poly(1,3,4-oxadiazole) polymer according to claim 8, wherein the sulfonated poly(1,3,4-oxadiazole) polymer has a molar ratio of sulfur to carbon of about 0.085 to about 0.38:1.

14. The sulfonated poly(1,3,4-oxadiazole) polymer according to claim 8, wherein the poly(1,3,4-oxadiazole) polymer is a poly(ether sulfone oxadiazole), a poly(ether ketone oxadiazole), a poly(ether amide oxadiazole) or a poly(ether imide oxadiazole).

15. The sulfonated poly(1,3,4-oxadiazole) polymer according to claim 8, wherein the polymer retains at least about 98% of its weight after one-hour immersion in Fenton's reagent at 80° C.

16. A membrane for fuel cells made of a sulfonated poly(1,3,4-oxadiazole) polymer according to claim 8, in which sulfonic acid groups are bonded with the main chain of the polymer, wherein the membrane has a feed side and a permeate side.

17. The membrane according to claim 16, wherein the membrane comprises a separation layer that contains mixtures or copolymers of the sulfonated poly(1,3,4-oxadiazole) polymer with other polymers.

18. The membrane according to claim 16, wherein the membrane is doped with acids and/or oligomers, which have functional acid groups and/or polymers with functional acid groups.

19. The membrane according to claim 16, wherein the membrane has a proton conductivity of at least about 4.9×10⁻² S/cm at 80° C. and relative humidity of about 15%.

20. A fuel cell with a membrane according to claim 16.

21. The fuel cell according to claim 20, wherein the fuel cell operates at a relative humidity of less than about 20%.

22. A method for the production of a fuel cell, comprising:
producing a membrane according to claim 16, the membrane having a feed side and a permeate side; and
disposing the membrane between two porous catalyst electrodes made of platinum or a platinum alloy;
wherein the feed side of the membrane contacts an anode and the permeate side of the membrane contacts a cathode.

23. The method according to claim 22, wherein the membrane comprises a layer made of a polymer electrolyte with the sulfonated poly(1,3,4-oxadiazole) polymer and/or copolymers which are derived from the sulfonated poly(1,3,4-oxadiazole) polymer, and wherein sulfonic acid groups are chemically or covalently bonded to the main polymer chains in the polymer electrolyte layer.

24. The method according to claim 23, wherein the layer has mixtures or copolymers of the polymers according to claim 8 with other polymers.

25. The method according to claim 22, wherein an anode is filled with a fuel that contains the components to be reacted, and wherein protons can migrate through the membrane.

26. The method according to claim 25, wherein the fuel supplied to the anode includes water, methanol, ethanol, or a mixture of one or more of thereof.

27. The method according to claim 26, wherein methanol or ethanol is used as liquids or mixtures of water and gaseous methanol or ethanol.

28. The method according to claim 22, wherein the space with the cathode contains an oxidizing agent.

29. The method according to claim 22, wherein the obtained components are pulled back into the cathode space.
